(19) United States
(12) Patent Application Publication
(10) Pub. No.: US 2009/0147513 A1
(43) Pub. Date: Jun. 11, 2009

(54) BACKLIGHTING LED POWER DEVICES

(75) Inventors: Boris Kolodin, Beachwood, OH (US); Emil Radkov, Euclid, OH (US); Srinath K. Aanegola, Broadview Heights, OH (US); Matthew L. Sommers, Sagamore Hills, OH (US); Mark J. Mayer, Sagamore Hills, OH (US); Christopher L. Bohler, North Royalton, OH (US)

Correspondence Address: Fay Sharpe LLP, 1228 Euclid Avenue, 5th Floor, The Halle Building, Cleveland, OH, 44115, US

(73) Assignee: Lumination LLC

(21) Appl. No.: 11/950,955

(22) Filed: Dec. 5, 2007

(51) Int. Cl. F21V 7/00; F21V 5/00; F21V 9/16

(52) U.S. Cl. 362/241; 362/235; 362/246; 362/84

(57) ABSTRACT

A generally planar illumination, display, or backlighting device is disclosed, including a generally planar arrangement of side emitting light emitting diode (LED) devices generating side emitted illumination, and a generally planar arrangement of wavelength conversion elements arranged coplanar with the generally planar arrangement of side emitting light emitting diode (LED) devices. The wavelength conversion elements are interspersed amongst the side emitting LED devices and configured to wavelength convert the side emitted illumination generated by the side emitting LED devices. A display device using such a generally planar illumination device is also disclosed, in which a liquid crystal display (LCD) panel is backlit by the generally planar illumination device.

### BACKGROUND

The following relates to the optoelectronic arts. It finds particular application in backlighting for liquid crystal display (LCD) devices, and will find more general application in conjunction with illumination generally, in lighting applications that would benefit from a high power planar light source, and so forth.

An LCD display includes a two-dimensional array of liquid crystal elements, or pixels, each comprising liquid crystal material (or a pixel-sized portion thereof) electrically coupled with a thin film transistor (TFT) or other localized electrical bias enabling opacity control. In some LCD displays, the opacity control may be on/off (providing a “half-tone” type display). More commonly, individual pixel opacity is continuously controllable to generate grayscale levels. To provide a color LCD display, the liquid crystal pixels further include color filters. For example, each pixel may have a red, green, or blue filter so as to define red, green, and blue pixel elements interspersed across the display to provide a full-color display.

Some LCD displays operate in reflection mode. However, these “non-backlit” displays are susceptible to washout in bright light, are inoperable in the dark, and generally have performance that is strongly dependent upon the ambient lighting conditions. More commonly, LCD displays are backlit by a planar backlight disposed in back of and parallel with the plane of the array of liquid crystal pixels. Backlit displays are less susceptible to washout in bright light, are operable in the dark, and generally exhibit performance that is less affected by ambient lighting conditions.

With the development of large-screen LCD televisions, there is strong interest in producing LCD displays with large area and high uniformity. This entails providing uniform backlighting across the area of the display or panel. In some approaches, the backlighting is provided by a serpentine fluorescent tube or an array of parallel linear fluorescent tubes coupled with planar diffusers. However, these backlights can suffer from less than satisfactory uniformity, and introduce robustness issues since fluorescent tubes are susceptible to breakage or performance degradation over time.

There is also interest in backlights constructed using light emitting diode (LED) devices. In one approach, a planar waveguide with forward-scattering texturing or other microstructure is used. LED devices arranged around the periphery of the planar waveguide inject light into the waveguide that is scattered in the forward direction by the texturing or other microstructure to produce uniform planar illumination. Some devices having this configuration are described, for example, in Sommers et al., U.S. Pat. No. 6,966,684. A texturing or microstructure distribution across the waveguide can be designed to provide high planar illumination uniformity, and the planar waveguide with the designed texturing can be precisely molded using known techniques. Thus, manufacturing is straightforward.

However, such “edge-lit” waveguide based backlights are difficult to scale up to large display areas. For example, a doubling of the display area length and width results in a doubling of the periphery along which light-injecting LED devices can be installed, but a fourfold increase in the display area that must be uniformly illuminated by those LED devices. As the display area increases, the ratio A/N (where A is the display area and N is the number of LED devices providing light injection) becomes unfavorably large. Moreover, at large display areas intrinsic absorption or scattering by the waveguide material can make it difficult for the injected light to reach the central region of the LCD display.

Another approach for addressing this problem is to use a two-dimensional array of LED devices arranged in back of and parallel with the plane of the array of liquid crystal pixels. Advantageously, the scaling problem is obviated—the number of LEDs in the two-dimensional array can increase linearly with the display area. However, uniformity has been an issue with this approach. The close proximity of individual LED devices to the array of liquid crystal pixels can produce bright spots at the LED device positions and darker regions in between these bright spots. This effect can be countered by the use of a thick diffuser plate, but this adversely impacts the display weight and thickness, and the diffuser plate may still not provide fully satisfactory display illumination uniformity.

Cohen et al., U.S. Pat. No. 6,697,042 discloses a configuration in which the diffuser plate is replaced by an optical cavity fitted over the array of LED devices. The diffuser plate has apertures with lenses on the opposite side. Thickness and weight are again issues, and furthermore the Cohen backlight is designed to provide collimated planar illumination. In contrast, LCD television and many other display applications are intended to have a wide viewing angle, and accordingly the collimated Cohen backlight is not suitable for these applications.

Heating is another concern if the LED devices are arranged close together in a two-dimensional array. Heating can be especially problematic for LED devices that employ a phosphor coating to convert electroluminescence generated by the LED chip, such as in white LED device configurations in which an LED chip emitting violet or ultraviolet light is coated by a white phosphor. In such devices operating in isolation, heating can produce optical losses ranging up to about 25%—even greater heating problems can be expected in a two-dimensional array configuration. Moreover, phosphors tend to exhibit performance degradation over time responsive to prolonged heat exposure.

The following discloses improvements in flexible lighting strips including light emitting diodes.

### BRIEF SUMMARY

In accordance with certain illustrative embodiments shown and described as examples herein, an illumination, display, or backlighting device is disclosed, comprising: a generally planar arrangement of side emitting light emitting diode (LED) devices generating side emitted illumination; and a generally planar arrangement of wavelength conversion elements arranged coplanar with the generally planar arrangement of side emitting light emitting diode (LED) devices, the wavelength conversion elements being interspersed amongst the side emitting LED devices and configured to wavelength convert the side emitted illumination generated by the side emitting LED devices.

In accordance with certain illustrative embodiments shown and described as examples herein, an illumination, display, or backlighting device is disclosed, comprising: side emitting light emitting diode (LED) devices arranged in a plane, each side emitting LED device comprising at least one LED chip; and wavelength conversion material arranged in the plane to receive side emitted illumination from the side emitting LED devices, the wavelength conversion material being arranged spaced apart from the LED chips.

In accordance with certain illustrative embodiments shown and described as examples herein, an illumination, display, or backlighting device is disclosed, comprising: a generally planar waveguide; and side emitting light emitting diode (LED) devices embedded in the generally planar waveguide and configured to emit side illumination in the plane of the generally planar waveguide while emitting substantially no illumination transverse to the plane of the generally planar waveguide.

Numerous advantages and benefits of the present invention will become apparent to those of ordinary skill in the art upon reading and understanding the present specification.

### BRIEF DESCRIPTION OF THE DRAWINGS

The invention may take form in various components and arrangements of components, and in various process operations and arrangements of process operations. The drawings are only for purposes of illustrating preferred embodiments and are not to be construed as limiting the invention.

FIGS. 1 and 2 diagrammatically show perspective and side-cross-sectional views, respectively, of a side-emitting light emitting diode (LED) device with coupled wavelength conversion element.

FIG. 3 diagrammatically shows a perspective view of an array of devices of the embodiment shown in FIGS. 1 and 2.

FIG. 4 diagrammatically shows a planar light source based on the array of devices of FIG. 3.

FIG. 5 diagrammatically shows a liquid crystal display (LCD) panel coupled with a backlight comprising the planar light source of FIG. 4.

FIG. 6 diagrammatically shows a side view of the array of devices of FIG. 3 with intervening light scattering elements.

FIG. 7 diagrammatically shows a side view of an array of devices similar to those of FIGS. 1 and 2 with modified reflectors.

FIG. 8 diagrammatically shows a planar light source employing side emitting LED devices embedded in a waveguide.

FIG. 9 diagrammatically shows a planar light source employing side emitting LED devices with bi-pyramidal reflective structures.

FIGS. 10 and 11 diagrammatically show conical and four-sided pyramidal embodiments that can be suitably used for the pyramidal portions of the bi-pyramidal reflective structures of FIG. 9.

### DETAILED DESCRIPTION OF PREFERRED EMBODIMENTS

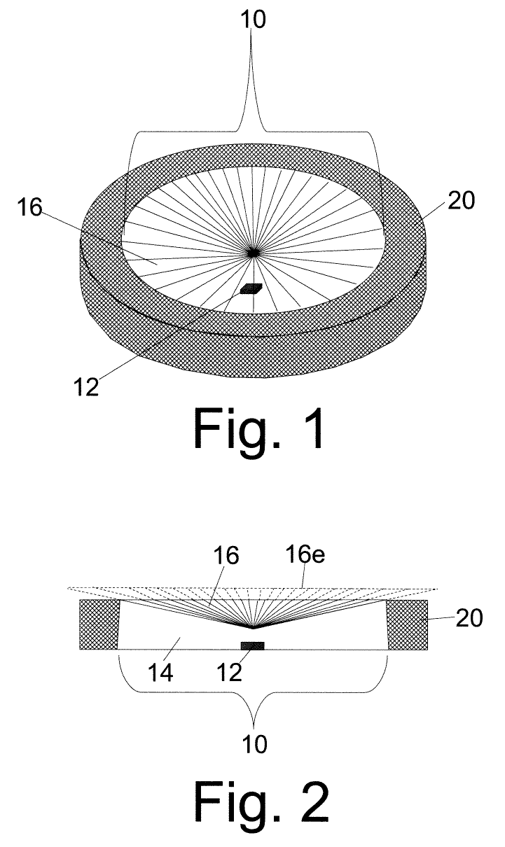

With reference to FIG. 1, a side emitting light emitting diode (LED) device 10 includes at least one LED chip 12, such as at least one group III-nitride chip, at least one group III-phosphide chip, or so forth, that is encapsulated by an encapsulant 14 that is transmissive for illumination generated by the at least one LED chip 12. The encapsulant 14 includes a generally conical, frustoconical, wedge-shaped, or otherwise-shaped depression on which a reflector 16 is disposed, such that the reflector has a generally conical, frustoconical, wedge-shaped, or otherwise-shaped surface facing the at least one LED chip 12. The reflector 16 intercepts light from the LED chip 12 directed transverse to the plane in which the LED chip 12 resides, and reflects such transverse light into a sideways direction to contribute to the side emission of illumination. As a result, the LED device 10 is a side emitter that emits illumination sideways but emits substantially no illumination in the transverse direction.

In the embodiment of FIG. 1, a wavelength conversion element 20 is further included. In the embodiment illustrated in FIG. 1, the wavelength conversion element 20 has the form of a generally annular ring of wavelength conversion material disposed at the periphery of the side emitting LED device 10. The generally annular wavelength conversion element 20 receives the side-emitted illumination from the side emitting LED device 10 and wavelength converts the light to a different wavelength or spectral range. For example, in some embodiments the wavelength conversion material comprises a phosphor composition of one or more phosphorescent or fluorescent materials dispersed in a matrix or host of epoxy, silicone, or so forth. In some embodiments, the side-emitted illumination is violet or ultraviolet and the wavelength conversion element 20 includes a mixture of reddish, greenish, bluish or other phosphor components in a stoichiometry selected to convert the violet or ultraviolet side-emitted illumination into white light. In other contemplated embodiments, other wavelength conversions are contemplated, such as blue side emitted illumination converted wholly or in part to yellowish light by the wavelength conversion material, or ultraviolet light converted to a saturated visible color by the wavelength conversion material, or so forth. The wavelength conversion performed by the wavelength conversion element 20 also reduces or eliminates the side emission directionality of the illumination, since typical phosphors, fluorphors, or so forth emit the wavelength converted light isotropically.

The wavelength conversion material of the wavelength conversion element 20 is spaced apart from the LED chip 12 at least by the encapsulant 14. Optionally, there may be an additional gap or space between the encapsulant 14 and the wavelength conversion element 20, which additional gap or space if included (not shown in FIG. 1) is transmissive for the side emitted illumination. Advantageously, spacing apart the wavelength conversion material from the LED chip 12 by at least the encapsulant 14 reduces or eliminates heating of the wavelength conversion material by the LED chip 12, which increases the overall efficiency of generation of wavelength converted light and reduces or eliminates heat-induced performance degradation over time. In some embodiments, the LED chip occupies less than or about one-tenth of an area contained inside the generally annular wavelength conversion element 20 so as to limit heating of the wavelength conversion material. However, other geometrical dimensions can be used.

The term “generally annular” as used herein is intended to encompass substantially any ring-shaped or looping structure. For example, a square or rectangular ring formed of four connecting sides is encompassed by the term “generally annular”, as is a substantially complete ring that includes one or more small gaps that break the ring continuity. The terms “light” and “illumination” as used herein are intended to encompass electromagnetic radiation in the visible spectrum and also in the neighboring infrared and ultraviolet spectral regions. The wavelength conversion material may convert the side emitted illumination either completely or partially, the latter configuration producing a blending of side emitted illumination and wavelength converted light. In some embodiments, it is contemplated to omit the wavelength conversion material entirely, such that the output of the device is the side emitted illumination. Still further, as used herein the term “side emitting LED device” is intended to encompass any electroluminescent diode device that generates side emitted illumination. For example, it is contemplated to replace the illustrated side emitting LED device 10 with an edge emitting semiconductor laser diode device, or with an LED device emitting primarily incoherent light but having some of the electrical and/or optical confinement features of an edge emitting semiconductor laser diode device. As used herein, the term “side emitting LED device” is intended to encompass edge emitting semiconductor laser diode devices.

With reference to FIG. 3, the devices shown in FIGS. 1 and 2 including side emitting LED devices 10 each surrounded by one of the generally annular wavelength conversion elements 20 are arranged in a generally planar arrangement to provide a planar illumination device. Advantageously, because each LED chip 12 is covered by the reflector 16, bright spots due to direct viewing of the LED chips 12 are avoided. With brief reference back to FIG. 2, in some embodiments the reflector 16 includes an annular extension 16e that extends over the annular wavelength converting element 20 to deflect light emitting transverse to the plane into the in-plane direction. The remote arrangement of the wavelength converting material reduces or eliminates efficiency losses and performance degradation over time due to heating. The spread out distribution of the wavelength converting material in the form of relatively large-circumference annuluses (compared with the size of the LED chips 12) further enhances lighting uniformity. The wavelength conversion material also tends to emit light isotropically, which further contributes to uniformity of the planar light output. As a result, the density of LED chips can be substantially reduced compared with two-dimensional planar LED sources that rely upon phosphor coated LED chips. Another advantage in the case of ultraviolet LED chips is that the ultraviolet light is trapped by the reflector 16 and, for a suitable annulus thickness of the generally annular wavelength converting element 20, is close to 100% converted by the generally annular wavelength converting element 20, so that little or no ultraviolet light escapes. Still further, the side emitting LED devices 10 are readily manufactured with low profiles, so that the generally planar light source provided by an array of the devices 10, 12 is a thin, low-profile planar light source.

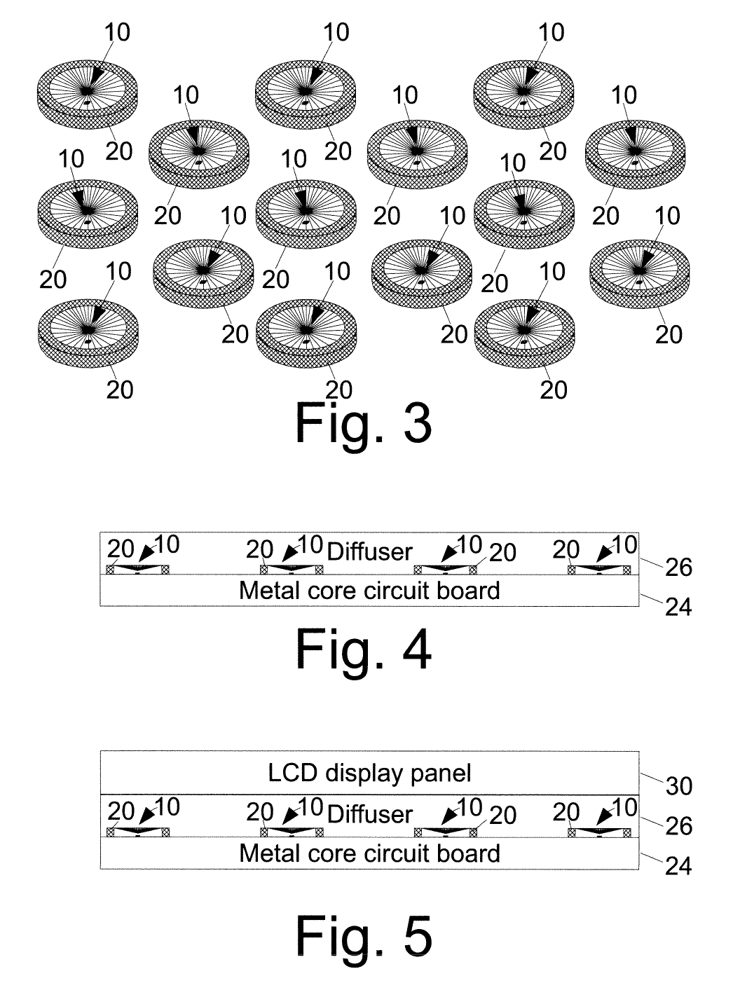

With reference to FIG. 4, a generally planar light source based on the generally planar arrangement of FIG. 3 suitably includes a metal core circuit board 24, such as a metal core printed circuit board (MCPCB), on which the side emitting LED devices 10 are mounted. The metal core circuit board 24 includes a planar heat sink of copper or another material having high heat conductivity and/or high heat capacity so as to provide heatsinking for the side emitting LED devices 10. Circuitry of the metal core circuit board 24 provides convenient electrical interconnection of the devices 10, 12 of the generally planar array of devices 10, 12. In some embodiments, the surface of the metal core circuit board 24 on which the devices 10, 12 are mounted is specularly reflective or diffusely scattering for the wavelength converted light, so as to recover “downward” directed wavelength converted light to enhance the efficiency and light output of the planar light source.

Additionally, in the planar light source embodiment of FIG. 4 the side emitting LED devices 10 and surrounding wavelength conversion elements 20 are embedded in a diffuser or waveguide element 26. In this way, the potential for dim spots over the side emitting LED devices 10 due to shadowing by the reflectors 16 is reduced or eliminated by scattering and/or waveguiding of the wavelength converted light that homogenizes the wavelength converted light intensity across the area of the planar illumination device. The illustrated diffuser or waveguide element 26 extends over the low-profile side emitting LED devices 10 to provide light scattering or waveguiding over these devices to ensure that the uniform light distribution encompasses the areas directly “above” the reflectors 16. Because bright spots due to direct viewing of the LED chips 12 are avoided, and the light is spread out and generally isotropic due to the distributed arrangement of the wavelength conversion elements 20, it follows that the diffuser or waveguide 26 can be made thinner than in comparable two-dimensional planar LED light sources that rely solely upon the thick diffuser to remove bright spots due to direct viewing of LED chips, while still providing light uniformity.

With reference to FIG. 5, the planar illumination device of FIG. 4 is suitably coupled with a liquid crystal display (LCD) panel 30 to provide backlighting for the LCD panel 30. The overall thickness of the display of FIG. 5 can be made small because of the thin diffuser or waveguiding element 26, and the low profiles of the side emitting LED devices 10 and coupled wavelength conversion elements 20. Although an LCD backlighting application is illustrated with reference to FIG. 5 as an example, it is to be appreciated that the planar illumination device of FIG. 4 can be used in substantially any application that benefits from a thin, high intensity planar illumination device. For example, the planar illumination device of FIG. 4 can also be used in illuminated signage, architectural lighting, and so forth.

One potential source of optical losses in the arrangements of FIGS. 3-5 is reabsorption of wavelength converted light by neighboring wavelength conversion elements 20. These losses are expected to be relatively small due to the relatively low density of LED devices in the array and the generally isotropic emission profile of the wavelength conversion material. However, reabsorption losses can be problematic in some specific embodiments. For example, if the annulus thickness of the generally annular wavelength conversion elements 20 is small compared with the height of these elements, then the emission profile for the wavelength conversion elements 20 may be biased toward in-plane emission by the high aspect ratio, and this anisotropic converted light emission profile may have enhanced susceptibility to reabsorption by neighboring high aspect-ratio wavelength conversion elements 20.

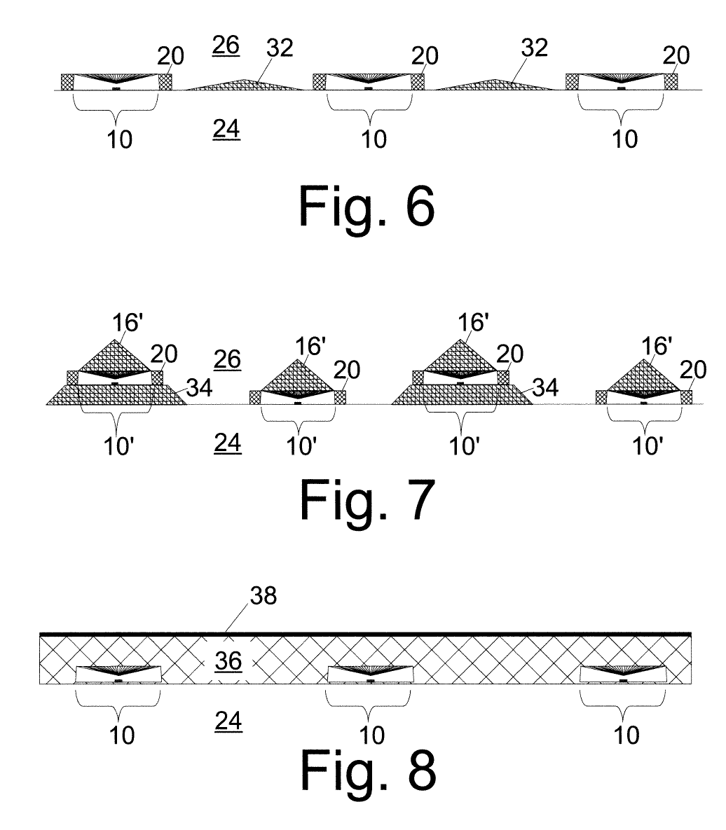

With reference to FIG. 6, one approach for reducing reabsorption losses is to embed light scattering elements 32 in the generally planar waveguide 26. In the illustrative embodiment shown in FIG. 6, the light scattering elements 32 are mounted on the metal core circuit board 24 and have a conical shape, frustoconical shape, wedge shape or other shape that promotes specular reflection or diffuse reflection or scattering of wavelength converted light traveling close to parallel to the plane of the planar light source. The reflected or scattered light can pass over the neighboring low profile wavelength conversion elements 20, thus avoiding optical loss and promoting light output uniformity in the areas over the reflectors 16.

FIG. 7 illustrates another contemplated approach for reducing reabsorption losses. In the embodiment of FIG. 7 a portion, such as half, of the side emitting LED devices 10 and their surrounding wavelength converting elements 20 are formed as elevated units by mounting on pedestals 34. This reduces the likelihood of reabsorption by placing some units above others. Optionally, the pedestals 34 can have slanted sides with specularly reflecting of diffusely reflecting or scattering surfaces, so that wavelength converted light emitted from non-elevated units that travels close to parallel with the plane of the planar light source are reflected by the pedestals 34 into a generally transverse direction to contribute to the light output of the planar light source. In similar fashion, the reflectors 16 are optionally replaced by modified reflectors 16′ that further promote reflection of the waveguided or scattered light into the transverse direction to contribute to the light output of the planar light source.

With reference to FIG. 8, another planar light source embodiment is described, which again employs the side emitting LED devices 10 mounted on the metal core circuit board 24 and embedded in a modified diffuser or waveguide element 36. In the embodiment of FIG. 8, the discrete wavelength converting elements 20 are omitted in favor of the modified planar diffuser or waveguide 36 which includes a low density of dispersed wavelength conversion material (diagrammatically indicated in FIG. 8 by a low-density crosshatching of the waveguide 36). Additionally, a wavelength-selective reflector 38 is disposed on top of the planar diffuser or waveguide 36.

The arrangement of FIG. 8 operates as follows. The side emitting LED devices 10 inject side emitted illumination, such as ultraviolet illumination in some embodiments, into the generally planar diffuser or waveguide 36. The wavelength-selective reflector 38 is tuned to reflect the side emitted illumination, but to transmit wavelength converted light produced by interaction of the side emitted illumination with the low density dispersion of wavelength conversion material. The surface of the metal core circuit board 24 is in this embodiment preferably reflective for both the side emitted illumination and the wavelength converted light. Accordingly, the side emitted illumination output by the side emitting LED devices 10 is substantially trapped within the diffuser or waveguide 36 between the wavelength-selective reflector 38 and the reflective surface of the circuit board 24. The trapped side emitted light interacts with and is wavelength converted by the low density of dispersed wavelength conversion material. The wavelength conversion process results in emission of generally isotropic wavelength converted light that, due to the tuning of the wavelength selective reflector 38, can readily escape from the diffuser or waveguide 36 to as a planar illumination output.

Instead of, or in addition to, the low density dispersion of wavelength conversion material, the generally planar waveguide 36 optionally includes a dispersed scattering material, such as dispersed alumina particles, dispersed small-volume voids or air pockets, or so forth. In embodiments in which the generally planar waveguide 36 includes dispersed scattering material but omits dispersed wavelength conversion material, the side emitted illumination from the side emitting LED devices 10 provides the light output of the planar light source without wavelength conversion. Although not illustrated, such embodiments can include light scattering elements such as the light scattering elements 32, and/or pedestals such as the pedestals 34, that are configured to reflect or scatter the side emitted illumination generated by the side emitting LED devices 10. It is also to be appreciated that the diffuser or waveguide 26 of FIGS. 4 and 5 may also include a dispersed scattering material, such as dispersed alumina particles, dispersed small-volume voids or air pockets, or so forth.

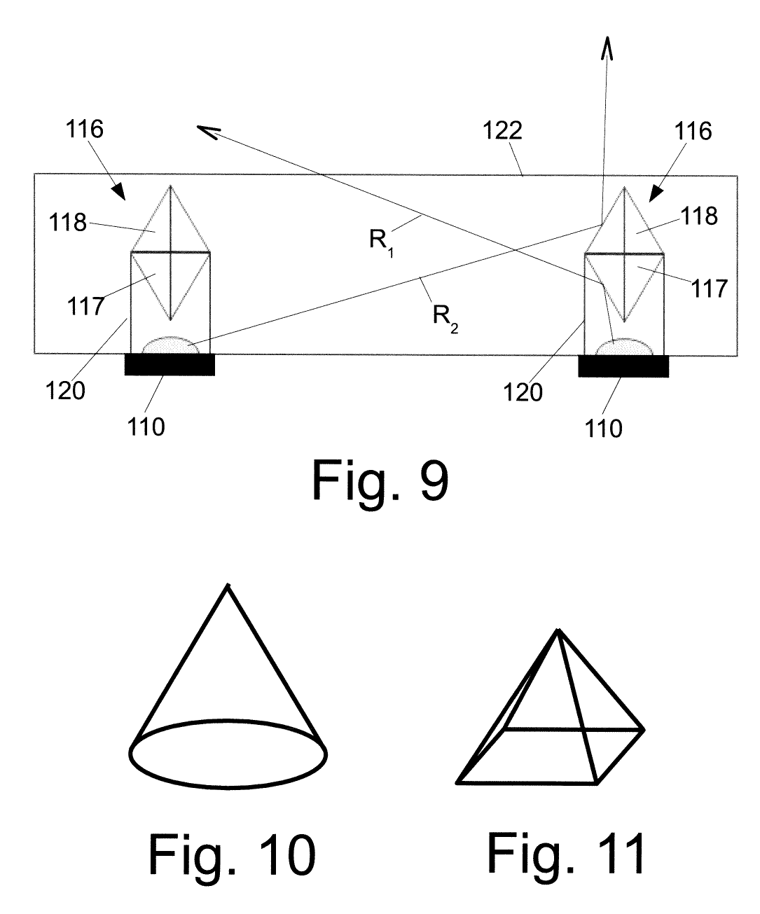

With reference to FIG. 9, another generally planar light source is described. This source employs LED devices 110. Associated with each LED device 110 is a bi-pyramidal reflector 116 having a proximate pyramidal portion 117 pointing toward the LED device 110 and a distal pyramidal portion 118 pointing away from the LED device 110. The proximate pyramidal portion 117 provides side scattering of light from the proximate LED device 110, as illustrated in FIG. 9 by a diagrammatic ray tracing R₁. The proximate pyramidal portion 117 serves a purpose similar to that of the reflector 16 of FIG. 1, for example. The distal pyramidal portion 118 provides generally forward scattering of side emitted light from other LED devices, as illustrated in FIG. 9 by a diagrammatic ray tracing R₂. The bi-pyramidal reflectors 116 are suitably fabricated as metal slugs, metal-coated plastic structures, or so forth, and each bi-pyramidal reflector 116 can be mounted respective to the corresponding LED device 110 by an epoxy, silicone, or other light transmissive connecting structure 120. The assemblies each including one of the LED devices 110, the corresponding bi-pyramidal reflector 116, and the optional connecting structure 120 are suitably embedded in a waveguide 122. Optionally, the connecting structure 120 may be omitted and the waveguide 122 used to provide the positioning of each bi-pyramidal reflector 116 respective to its corresponding LED device 110.

With reference to FIGS. 10 and 11, the proximate and distal pyramidal portions 117, 118 can have various pyramidal shapes, such as a conical pyramidal shape illustrated in FIG. 10 or a four-sided pyramidal shape illustrated in FIG. 11. Other pyramidal shapes contemplated include shapes with other than four planar sides (e.g., three, five, six, or more planar sides), shapes with three, four, or more sloped sides, or so forth.

The preferred embodiments have been illustrated and described. Obviously, modifications and alterations will occur to others upon reading and understanding the preceding detailed description. It is intended that the invention be construed as including all such modifications and alterations insofar as they come within the scope of the appended claims or the equivalents thereof.

1. An illumination, display, or backlighting device comprising:
a generally planar arrangement of side-emitting light emitting diode (LED) devices generating side-emitted illumination; and
a generally planar arrangement of wavelength conversion elements arranged coplanar with the generally planar arrangement of side-emitting light emitting diode (LED) devices, the wavelength conversion elements being interspersed amongst the side-emitting LED devices and configured to wavelength-convert the side-emitted illumination generated by the side-emitting LED devices.

2. The illumination, display, or backlighting device as set forth in claim 1, further comprising:
a generally planar optical diffuser element, the generally planar arrangement of side-emitting LED devices being arranged parallel with or embedded in the generally planar optical diffuser element.

3. The illumination, display, or backlighting device as set forth in claim 1, further comprising:
a generally planar liquid crystal display (LCD) panel arranged parallel with the generally planar arrangement of side-emitting LED devices to receive backlighting from the generally planar arrangement of side-emitting LED devices after wavelength conversion by the wavelength conversion elements.

4. The illumination, display, or backlighting device as set forth in claim 1, wherein each wavelength conversion element is generally annular and surrounds one of the side-emitting LED devices.

5. The illumination, display, or backlighting device as set forth in claim 4, wherein each side-emitting LED device includes a reflector arranged to form the side-emitted illumination by reflecting illumination generated by at least one optically coupled LED chip.

6. The illumination, display, or backlighting device as set forth in claim 5, wherein the LED chip occupies less than or about one-tenth of an area contained inside the generally annular wavelength conversion element.

7. The illumination, display, or backlighting device as set forth in claim 5, wherein the reflectors include generally conically shaped portions extending away from the least one optically coupled LED chip.

8. The illumination, display, or backlighting device as set forth in claim 5, wherein the least one optically coupled LED chip of each side-emitting LED device is encapsulated by an encapsulant disposed inside of the surrounding generally annular wavelength conversion element, the encapsulant being transmissive for said illumination and serving as a support for the reflector.

9. The illumination, display, or backlighting device as set forth in claim 8, wherein the encapsulant of each side-emitting LED device fills an interior volume bounded by the reflector and an inner surface of the generally annular wavelength conversion element.

10. The illumination, display, or backlighting device as set forth in claim 4, wherein the generally annular wavelength conversion elements include elevated generally annular wavelength conversion elements, the elevated generally annular wavelength conversion elements and the side-emitting LED devices surrounded by the elevated generally annular wavelength conversion elements being elevated on pedestals.

11. The illumination, display, or backlighting device as set forth in claim 1, wherein the side-emitted illumination generated by the side-emitting LED devices comprises violet or ultraviolet illumination and the wavelength conversion elements convert said violet or ultraviolet illumination to white light.

12. An illumination, display, or backlighting device comprising:
side-emitting light emitting diode (LED) devices arranged in a plane, each side-emitting LED device comprising at least one LED chip; and
wavelength conversion material arranged in the plane to receive side-emitted illumination from the side-emitting LED devices, the wavelength conversion material being arranged spaced apart from the LED chips.

13. The illumination, display, or backlighting device as set forth in claim 12, wherein each side-emitting LED device further comprises an encapsulant encapsulating the at least one LED chip and a side-emitting reflector disposed on the encapsulant and optically coupled with the at least one LED chip via the encapsulant, the wavelength conversion material being arranged spaced apart from each LED chip by at least the encapsulating encapsulant.

14. The illumination, display, or backlighting device as set forth in claim 13, wherein the wavelength conversion material is arranged as annular ring elements each surrounding a periphery of one of the side-emitting LED devices.

15. The illumination, display, or backlighting device as set forth in claim 13, further comprising:
a generally planar waveguide disposed in the plane, the side-emitting LED devices and the wavelength conversion material being embedded in the generally planar waveguide.

16. The illumination, display, or backlighting device as set forth in claim 15, wherein the wavelength conversion material is arranged as annular ring elements each embedded in the generally planar waveguide and surrounding a periphery of one of the side-emitting LED devices

17. The illumination, display, or backlighting device as set forth in claim 15, wherein the wavelength conversion material is dispersed in the generally planar waveguide.

18. The illumination, display, or backlighting device as set forth in claim 12, wherein the side-emitting LED devices are arranged at staggered heights in the plane.

19. The illumination, display, or backlighting device as set forth in claim 12, further comprising:
a liquid crystal display (LCD) panel arranged to be backlit by the cooperating light emitting diode LED devices and wavelength conversion material.

20. An illumination, display, or backlighting device comprising:
a generally planar waveguide; and
side emitting light emitting diode (LED) devices embedded in the generally planar waveguide and configured to emit side illumination in the plane of the generally planar waveguide while emitting substantially no illumination transverse to the plane of the generally planar waveguide.

21. The illumination, display, or backlighting device as set forth in claim 20, further comprising:
wavelength conversion material embedded or dispersed in the generally planar waveguide and spaced apart from the side emitting LED chips, the wavelength conversion material being configured to wavelength convert the side illumination.

22. The illumination, display, or backlighting device as set forth in claim 21, wherein the wavelength conversion material is arranged as discrete elements embedded in the generally planar waveguide.

23. The illumination, display, or backlighting device as set forth in claim 21, wherein the side illumination is violet or ultraviolet and the wavelength conversion material wavelength converts the side illumination to white light.

24. The illumination, display, or backlighting device as set forth in claim 20, further comprising:
light scattering material embedded or dispersed in the generally planar waveguide and spaced apart from the side emitting LED chips, the light scattering material being configured to scatter the side illumination to generate light oriented transverse to the generally planar waveguide.

25. The illumination, display, or backlighting device as set forth in claim 20, wherein the side-emitting LED devices each comprise:
an LED device; and
a bi-pyramidal reflector having a proximate pyramidal portion pointing toward the LED device to side scatter light from the LED device and a distal pyramidal portion pointing away from the LED device to generally forward scatter light from other side-emitting LED devices.
